(19) United States
(12) Patent Application Publication
(10) Pub. No.: US 2022/0321280 A1
(43) Pub. Date: Oct. 6, 2022

(54) METHOD OF HARQ PROCESS FOR MULTICAST BROADCAST SERVICE AND USER EQUIPMENT USING THE SAME

(71) Applicant: FG Innovation Company Limited, New Territories (HK)

(72) Inventors: Chia-Hung Wei, Taipei City (TW); Hai-Han Wang, Taipei City (TW); Hung-Chen Chen, Taipei City (TW); Heng-Li Chin, Taipei City (TW)

(73) Assignee: FG Innovation Company Limited, New Territories (HK)

(21) Appl. No.: 17/709,428

(22) Filed: Mar. 31, 2022

Related U.S. Application Data
(60) Provisional application No. 63/169,126, filed on Mar. 31, 2021.

(51) Int. Cl. H04L 1/18; H04W 72/12; H04W 4/06

(52) U.S. Cl. CPC H04L 1/1854; H04W 72/1289; H04L 1/1812; H04W 4/06

(57) ABSTRACT

A method of HARQ process for MBS and a UE using the same method are provided. The method includes: receiving first DCI on a first PDCCH scrambled by a first RNTI, wherein the first DCI comprises a first NDI value and schedules a first downlink data reception corresponding to a HARQ process; receiving second DCI on a second PDCCH scrambled by a second RNTI, wherein the second DCI comprises a second NDI value and schedules a second downlink data reception corresponding to the HARQ process; identifying a first type of the first RNTI and a second type of the second RNTI; and determining, according to the first type and the second type, whether the first NDI value and the second NDI value are used for determining the second downlink data reception corresponds to an initial transmission or a retransmission of the first downlink data reception.

### CROSS-REFERENCE TO RELATED APPLICATION

The present application claims the benefit of and priority to U.S. Provisional Patent Application Ser. No. 63/169,126, filed on Mar. 31, 2021, entitled “DATA RECEPTION WITH HARQ RETRANSMISSION FOR MBS” with Attorney Docket No. US84688, the content of which is hereby incorporated fully by the reference herein into the present disclosure.

### BACKGROUND

### Technical Field

The present disclosure generally relates to wireless communication, and more particular, a method of hybrid automatic repeat request (HARQ) process for multicast broadcast service (MBS) and a user equipment (UE) using the same method.

### Description of Related Art

With the tremendous growth in the number of connected devices and the rapid increase in user/network traffic volume, various efforts have been made to improve different aspects of wireless communication for the next-generation wireless communication system, such as the fifth generation (5G) New Radio (NR), by improving data rate, latency, reliability, and mobility.

The 5G NR system is designed to provide flexibility and configurability to optimize the network services and types, accommodating various use cases, such as enhanced Mobile Broadband (eMBB), massive Machine-Type Communication (mMTC), and Ultra-Reliable and Low-Latency Communication (URLLC).

According to latest progress of standardize work for MBS in current 3GPP Radio Access Network (RAN) working group 2 (i.e., RAN2), MBS data transmission in NR having two transmission modes: point to multipoint (PTM) and point to point (PTP). In order to let the MBS service be gained with high reliability, it is assumed that the MBS data transmitted by gNB either via PTM or PTP may be protected with HARQ retransmission. This implies the MBS data reception on UE side may be relied on HARQ processing. That is, the UE may perform received data decoding, received data buffering and/or soft combing for data with different redundancy version (RV). These works were mainly handled by a particular HARQ process identified by a HARQ process ID and indicated by gNB. For example, downlink (DL) data assignment made by gNB may bundle with a HARQ process ID assignment. Furthermore, the UE should also trigger HARQ-ACK feedback according to the result of reception and corresponding HARQ processing. A DL data retransmission rely on same HARQ process (ID) may be performed by gNB based on receiving the HARQ-ACK feedback subsequently. By including a new data indicator (NDI) field carried within downlink control information (DCI) applied for corresponding data assignment, UE is indicated with whether the downlink data assignment for an HARQ process is for initial transmission or for retransmission.

However, once the data retransmission is introduced for MBS data assignment, it is not clear how a gNB indicates UE corresponding information under both of the PTM and PTP transmission modes. Furthermore, once the transmission mode applied by the gNB for MBS data transmission can be dynamically changed (switched), it brings serious challenges and complexities on how gNB properly indicates UE each scheduled DL data reception is for initial transmission or is for retransmission. For example, it is possible a gNB schedule a retransmit data reception to a UE via PTP while the initial transmission was scheduled via PTP, or vice versa. In these scenarios, it brings significant challenges to a gNB on correctly indicates UE a DL data transmission is initial transmission or retransmission via current NDI.

### SUMMARY

The present disclosure is directed to a method of hybrid automatic repeat request (HARQ) process for multicast broadcast service (MBS) and a user equipment (UE) using the same method.

The disclosure provides a method of hybrid automatic repeat request (HARQ) process for multicast broadcast service (MBS), adapted to a user equipment (UE), wherein the method including: receiving first downlink control information (DCI) on a first physical downlink control channel (PDCCH) scrambled by a first radio network temporary identifier (RNTI), wherein the first DCI includes a first new data indicator (NDI) value and schedules a first downlink data reception on a first physical downlink shared channel (PDSCH) corresponding to a HARQ process; receiving second DCI on a second PDCCH scrambled by a second RNTI, wherein the second DCI includes a second NDI value and schedules a second downlink data reception on a second PDSCH corresponding to the HARQ process; identifying a first type of the first RNTI and a second type of the second RNTI; and determining, according to the first type and the second type, whether the first NDI value and the second NDI value are used for determining the second downlink data reception corresponds to an initial transmission or a retransmission of the first downlink data reception.

In one embodiment of the disclosure, the method further including: in response to the second type corresponding to a group RNTI and the first type corresponding to a UE specific RNTI, determining the second downlink data reception corresponds to the initial transmission or the retransmission without using the first NDI value and the second NDI value.

In one embodiment of the disclosure, the step of determining the second downlink data reception corresponds to the initial transmission or the retransmission without using the first NDI value and the second NDI value including: in response to the second type being different from the first type, determining the second downlink data reception is the initial transmission.

In one embodiment of the disclosure, the method further including: receiving a radio resource control (RRC) message indicating a group RNTI associated with an MBS bearer.

In one embodiment of the disclosure, the method further including: in response to both of the first type and the second type corresponding to a group RNTI, determining the second downlink data reception corresponds to the initial transmission or the retransmission by using the first NDI value and the second NDI value.

In one embodiment of the disclosure, the step of determining the second downlink data reception corresponds to the initial transmission or the retransmission by using the first NDI value and the second NDI value including: determining the second downlink data reception corresponds to the initial transmission in response to the second NDI value being different from the first NDI value; and determining the second downlink data reception corresponds to the retransmission in response to the second NDI value being the same as the first NDI value.

In one embodiment of the disclosure, the method further including: in response to the second type corresponding to a UE specific RNTI, determining the second downlink data reception corresponds to the initial transmission or the retransmission by using the first NDI value and the second NDI value.

In one embodiment of the disclosure, the step of determining the second downlink data reception corresponds to the initial transmission or the retransmission by using the first NDI value and the second NDI value including: determining the second downlink data reception corresponds to the initial transmission in response to the second NDI value being different from the first NDI value; and determining the second downlink data reception corresponds to the retransmission in response to the second NDI value being the same as the first NDI value.

In one embodiment of the disclosure, the method further including: decoding data from the second downlink data reception in response to determining the second downlink data reception corresponds to the initial transmission; and soft combining data received from the first downlink data reception and the second downlink data reception in response to determining the second downlink data reception corresponds to the retransmission.

The disclosure provides a user equipment, including: one or more non-transitory computer-readable media having computer-executable instructions embodied thereon; and at least one processor coupled to the one or more non-transitory computer-readable media, and configured to execute the computer-executable instructions to: receive first downlink control information (DCI) on a first physical downlink control channel (PDCCH) scrambled by a first radio network temporary identifier (RNTI), wherein the first DCI includes a first new data indicator (NDI) value and schedules a first downlink data reception corresponding to a HARQ process on a first physical downlink shared channel (PDSCH); receive second DCI on a second PDCCH scrambled by a second RNTI value, wherein the second DCI includes a second NDI value and schedules a second downlink data reception corresponding to the HARQ process on a second PDSCH; identify a first type of the first RNTI and a second type of the second RNTI; and determine, according to the first type and the second type, whether the first NDI value and the second NDI value are used for determining the second downlink data reception corresponds to an initial transmission or a retransmission of a data packet obtained from the first downlink data reception.

In view of foregoing, the present disclosure provides a method for a UE in the MBS-based network to identify the transmission type (e.g., initial transmission or retransmission) of received data packets correctly even if the transmission mode (e.g., PTP or PTM) may be changed dynamically by the base station and the UEs in the same group perform HARQ processes by using the same HARQ process ID.

To make the aforementioned more comprehensible, several embodiments accompanied with drawings are described in detail as follows.

### BRIEF DESCRIPTION OF THE DRAWINGS

Aspects of the exemplary disclosure are best understood from the following detailed description when read with the accompanying figures. Various features are not drawn to scale, and dimensions of various features may be arbitrarily increased or reduced for clarity of discussion.

FIG. 1 illustrates a schematic diagram of protocol stack of UE for MBS configured with separated RLC entities according to an embodiment of the present disclosure.

FIG. 2 illustrates a schematic diagram of protocol stack of UE for MBS configured with a common RLC entity according to an embodiment of the present disclosure.

FIG. 3 illustrates a schematic diagram of PTM transmission schemes according to an embodiment of the present disclosure.

FIG. 4 illustrates a schematic diagram of HARQ process according to an embodiment of the present disclosure.

FIG. 5 illustrates a flowchart of a HARQ process according to an embodiment of the present disclosure.

FIG. 6 illustrates a flowchart of a method of HARQ process for MBS according to an embodiment of the present disclosure.

FIG. 7 illustrates a schematic diagram of scenarios of HARQ processes according to an embodiment of the present disclosure.

FIG. 8 illustrates a schematic diagram of HARQ processes pools according to an embodiment of the present disclosure.

FIG. 9 illustrates a schematic diagram of scenarios E1 and E2 according to an embodiment of the present disclosure.

FIG. 10 illustrates a schematic diagram of scenario F according to an embodiment of the present disclosure.

FIG. 11 illustrates a schematic diagram of scenarios G1 and G2 according to an embodiment of the present disclosure.

FIG. 12 illustrates a schematic diagram of scenario H according to an embodiment of the present disclosure.

FIG. 13 illustrates a flowchart of a method of HARQ process for MBS according to an embodiment of the present disclosure.

FIG. 14 illustrates a block diagram of a node for wireless communication according to an embodiment of the present disclosure.

### DESCRIPTION OF THE EMBODIMENTS

The acronyms in the present disclosure are defined as follows and unless otherwise specified, the acronyms have the following meanings:

| Acronym | Full name |
|---|---|
| 3GPP | 3rd Generation Partnership Project |
| 5GC | 5G Core |
| ACK | Acknowledgement |
| ARQ | Automatic Repeat Request |
| AS | Access Stratum |
| BS | Base Station |
| BWP | Bandwidth Part |
| CA | Carrier Aggregation |
| CN | Core Network |
| CORESET | Control Resource Set |
| CSI-RS | Channel State Information Reference Signal |
| CS-RNTI | Configured Scheduling Radio Network Temporary Identifier |
| C-RNTI | Cell-Radio Network Temporary Identifier |
| DC | Dual Connectivity |
| DCI | Downlink Control Information |
| DL | Downlink |
| DL-SCH | Downlink Shared Channel |
| DRB | (user) Data Radio Bearer |
| DRX | Discontinuous Reception |
| DTCH | Dedicated Traffic Channel |
| EN-DC | E-UTRA NR Dual Connect |
| HARQ | Hybrid Automatic Repeat Request |
| IE | Information Element |
| LCH | Logical Channel |
| LCID | Logical Channel Identity |
| MAC | Medium Access Control |
| MAC CE | MAC Control Element |
| MBS | Multicast Broadcast Service |
| MBMS | Multimedia Broadcast Multicast Services |
| MBSFN | Multicast Broadcast Single Frequency Network |
| MCG | Master Cell Group |
| MCS-C-RNTI | Modulation Coding Scheme Cell Radio Network Temporary Identifier |
| NAS | Non-Access Stratum |
| NDI | New Data Indicator |
| NG-RAN | Next-Generation Radio Access Network |
| NR | New Radio |
| NW | Network |
| PCell | Primary Cell |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical Layer |
| PRACH | Physical Random Access Channel |
| PTM | Point to Multipoint |
| PTP | Point to Point |
| PUCCH | Physical Uplink Control Channel |
| PUSCH | Physical Uplink Shared Channel |
| QoS | Quality of Service |
| RA | Random Access |
| RACH | Random Access Channel |
| RAN | Radio Access Network |
| Rel | Release |
| RLC | Radio Link Control |
| RNTI | Radio Network Temporary Identifier |
| RRC | Radio Resource Control |
| RSRP | Reference Signal Received Power |
| SCell | Secondary Cell |
| SCG | Secondary Cell Group |
| SCS | Sub Carrier Spacing |
| SDAP | Service Data Adaptation Protocol |
| SDU | Service Data Unit |
| SFN | System Frame Number |
| SI | System Information |
| SLIV | Start and Length Indicator Value |
| SUL | Supplementary UL |
| SSB | Synchronization Signal Block |
| TAG | Timing Advance Group |
| TB | Transport Block |
| TMGI | Temporary Mobile Group Identity |
| TS | Technical Specification |
| UCI | Uplink Control Information |
| UE | User Equipment |
| UL | Uplink |

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”, which specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Any sentence, paragraph, (sub)-bullet, point, action, behavior, term, alternative, aspect, example, or claim described in the present disclosure may be combined logically, reasonably, and properly to form a specific method. Any sentence, paragraph, (sub)-bullet, point, action, behavior, term, alternative, aspect, example, or claim described in the present disclosure may be implemented independently and separately to form a specific method. Dependency, e.g., “based on”, “more specifically”, “in some implementations”, “in one alternative”, “in one example”, “in one aspect”, or etc., in the present disclosure is just one possible example in which would not restrict the specific method. One aspect of the present disclosure may be used, for example, in a communication, communication equipment (e.g., a mobile telephone apparatus, ad base station apparatus, a wireless LAN apparatus, and/or a sensor device, etc.), and integrated circuit (e.g., a communication chip) and/or a program, etc. According to any sentence, paragraph, (sub)-bullet, point, action, behavior, term, alternative, aspect, example, implementation, or claim described in the present disclosure, “X/Y” may include the meaning of “X or Y”. According to any sentence, paragraph, (sub)-bullet, point, action, behavior, term, alternative, aspect, example, implementation, or claim described in the present disclosure, “X/Y” may also include the meaning of “X and Y”. According to any sentence, paragraph, (sub)-bullet, point, action, behavior, term, alternative, aspect, example, implementation, or claim described in the present disclosure, “X/Y” may also include the meaning of “X and/or Y”.

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network function(s) or algorithm(s). The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G NR Radio Access Network (RAN)) typically includes at least one base station, at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a RAN established by one or more base stations.

It should be noted that, in the present disclosure, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A base station may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, eLTE (evolved LTE, e.g., LTE connected to 5GC), NR (often referred to as 5G), and/or LTE-A Pro. However, the scope of the present disclosure should not be limited to the above-mentioned protocols.

A base station may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The base station may be operable to provide radio coverage to a specific geographical area using a plurality of cells included in the RAN. The BS may support the operations of the cells. Each cell may be operable to provide services to at least one UE within its radio coverage. Specifically, each cell (often referred to as a serving cell) may provide services to serve one or more UEs within its radio coverage (e.g., each cell schedules the Downlink (DL) and optionally Uplink (UL) resources to at least one UE within its radio coverage for DL and optionally UL packet transmission). The BS may communicate with one or more UEs in the radio communication system through the plurality of cells.

A cell may allocate sidelink (SL) resources for supporting Proximity Service (ProSe) or Vehicle to Everything (V2X) services. Each cell may have overlapped coverage areas with other cells. In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

In addition, the terms “system” and “network” herein may be used interchangeably. The term “and/or” herein is only an association relationship for describing associated objects, and represents that three relationships may exist. For example, A and/or B may indicate that: A exists alone, A and B exist at the same time, or B exists alone. In addition, the character “/” herein generally represents that the former and latter associated objects are in an “or” relationship.

As discussed above, the next-generation (e.g., 5G NR) wireless network is envisioned to support more capacity, data, and services. A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG is a set of one or more serving cells including the PCell and zero or more secondary cells. Conversely, the SCG is a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the MR-DC mode, the PCell may belong to the MN. The Primary SCG Cell (PSCell) may be an SCG cell in which the UE performs random access (e.g., when performing the reconfiguration with a sync procedure). In MR-DC, the PSCell may belong to the SN. A Special Cell (SpCell) may be referred to a PCell of the MCG, or a PSCell of the SCG, depending on whether the MAC entity is associated with the MCG or the SCG. Otherwise, the term Special Cell may refer to the PCell. A Special Cell may support a Physical Uplink Control Channel (PUCCH) transmission and contention-based Random Access (CBRA), and may always be activated. Additionally, for a UE in an RRC_CONNECTED state that is not configured with the CA/DC, may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

The terms and definitions in the present disclosure are descripted as follows and unless otherwise specified, the terms and definitions have the following meanings:

Cell: Radio network object that can be uniquely identified by a User Equipment from a (cell) identification that is broadcasted over a geographical area from one UTRAN Access Point. A Cell is either frequency-division duplexing (FDD) or time-division duplexing (TDD) mode.

Serving Cell: For a UE in RRC_CONNECTED not configured with CA/DC there is only one serving cell comprising of the primary cell. For a UE in RRC_CONNECTED configured with CA/DC the term “serving cells” is used to denote the set of cells comprising of the Special Cell(s) and all secondary cells.

CA: In Carrier Aggregation (CA), two or more Component Carriers (CCs) are aggregated. A UE may simultaneously receive or transmit on one or multiple CCs depending on its capabilities. CA is supported for both contiguous and non-contiguous CCs. When CA is deployed frame timing and SFN are aligned across cells that can be aggregated. The maximum number of configured CCs for a UE is 16 for DL and 16 for UL. When CA is configured, the UE only has one RRC connection with the network. At RRC connection establishment/re-establishment/handover, one serving cell provides the NAS mobility information, and at RRC connection re-establishment/handover, one serving cell provides the security input. The serving cell is referred to as the Primary Cell (PCell). Depending on UE capabilities, Secondary Cells (SCells) can be configured to form together with the PCell a set of serving cells. The configured set of serving cells for a UE therefore always consists of one PCell and one or more SCells.

HARQ: A functionality ensures delivery between peer entities at Layer 1 (i.e., Physical Layer). A single HARQ process supports one Transport Block (TB) when the physical layer is not configured for downlink/uplink spatial multiplexing, and when the physical layer is configured for downlink/uplink spatial multiplexing, a single HARQ process supports one or multiple TBs. There is one HARQ entity per serving cell. Each of HARQ entity supports a parallel (number) of DL and UL HARQ process.

Hybrid automatic repeat request acknowledgement (HARQ-ACK): A HARQ-ACK information bit value of “0” represents a negative acknowledgement (NACK) while a HARQ-ACK information bit value of “1” represents a positive acknowledgement (ACK).

BWP: A subset of the total cell bandwidth of a cell is referred to as a Bandwidth Part (BWP) and BA is achieved by configuring the UE with BWP(s) and telling the UE which of the configured BWPs is currently the active one. To enable Bandwidth Adaptation (BA) on the PCell, the gNB configures the UE with UL and DL BWP(s). To enable BA on SCells in case of CA, the gNB configures the UE with DL BWP(s) at least (i.e. there may be none in the UL). For the PCell, the initial BWP is the BWP used for initial access. For the SCell(s), the initial BWP is the BWP configured for the UE to first operate at SCell activation. UE may be configured with a first active uplink BWP by a firstActiveUplinkBWP IE. If the first active uplink BWP is configured for an SpCell, the firstActiveUplinkBWP IE field contains the ID of the UL BWP to be activated upon performing the RRC (re-)configuration. If the field is absent, the RRC (re-)configuration does not impose a BWP switch. If the first active uplink BWP is configured for an SCell, the firstActiveUplinkBWP IE field contains the ID of the uplink bandwidth part to be used upon MAC-activation of an SCell.

PDCCH: In the downlink, the gNB can dynamically allocate resources to UEs at least via the C-RNTI/MCS-C-RNTI/CS-RNTI on PDCCH(s). A UE always monitors the PDCCH(s) in order to find possible assignments when its downlink reception is enabled (activity governed by DRX when configured). When CA is configured, the same C-RNTI applies to all serving cells.

PDSCH/PUSCH: The PDCCH can be used to schedule DL transmissions on PDSCH and UL transmissions on PUSCH.

Transport Block: The data from the upper layer (or MAC) given to the physical layer is basically referred as transport block.

The terms, definitions and abbreviations as given in the present disclosure are either imported from existing documentation (ETSI, ITU or elsewhere) or newly created by 3GPP experts whenever the need for precise vocabulary was identified.

Worldwide telecommunication standard development organization(s), leading by 3rd Generation Partnership Project (3GPP), had introduced Multimedia Broadcast Multicast Services (MBMS) for Long Term Evolution (LTE) cellular wireless communication system, in earlier releases, based on a standardized point to multipoint (PTM) interface. The MBMS was introduced for providing an efficient way of broadcast and multicast data (or packet) delivery either within a cell (via single cell point to multipoint (SC-PTM)) or within multiple cells (via Multimedia Broadcast Multicast Service Single Frequency Network (MBSFN)) belong to same core network.

From the Access-Stratum (AS) layer perspective, the data processing flow designed for MBMS data had significant differences from the unicast as in legacy. For example, the multicast data transmission was delivered through MBMS specific logical channels which were isolated from logical channel(s) configured for normal data process (i.e., delivery and reception). That is, to support MBMS on a UE, the UE should be (pre)configured with particular MBMS configuration for at least its protocol stack (e.g., RRC, PDCP, RLC, MAC and PHY layer). For example, the UE should at least be configured with control channel (i.e., Multicast Control Channel (MCCH)) and traffic channel (i.e., Multicast Traffic Channel (MTCH)) in case of the supported MBMS was among multiple cells belong to single core network. Similarly, the UE should at least be configured with control channel (i.e., Single-Cell Multicast Control Channel (SC-MCCH)) and traffic channel (i.e., Single-Cell Multicast Traffic Channel (SC-MTCH)) in case of the supported MBMS is within a cell, wherein the MCCH and SC-MCCH are point-to-multipoint downlink channels used for transmitting MBMS control information from the network to the UE, for one or several MTCHs and SC-MTCHs. The MTCH and SC-MTCH are point-to-multipoint downlink channel for transmitting traffic data from the network (e.g., eNB) to the UE.

A MAC entity of a UE, in New Radio (NR), may consists of a number of HARQ entities and each associate with a configured serving cell. The each of HARQ entity may support more than one (a parallel of) DL and/or UL HARQ process; While receiving DL data from the gNB, a DL HARQ process may at least having responsibility on handling: determining whether each data reception is new transmission or retransmission; decoding received DL data and coming out corresponding TB; buffering each received data and performing soft combining on the received data; or performing HARQ feedback.

Physical Downlink Control Channel: In New Radio (NR) wireless communication system, a downlink data reception at UE side is achieved by monitoring physical downlink control channel (PDCCH) and find possible assignment, wherein the assignment represented as a (UE specific) downlink control information (DCI). The DCI is found on PDCCH via blind decoding. From the implementation of blind decoding aspect, the UE may be configured with a set of PDCCH candidates within one or more CORESET. The PDCCH candidate set for the UE to monitor is defined in terms of PDCCH search space sets (or search space sets). A search space set can be categorized into two types (i.e., either a Common Search space (CSS) set or a UE Specific Search Space (USS) set). That is, a UE may monitor PDCCH candidates according to one or more configured search spaces sets to decode possible PDCCH transmitted by the gNB. In other words, a PDCCH may be found in the PDCCH candidates within the monitored search space sets. From more further details of implementation perspective, the UE may monitor a set of PDCCH candidates in one or more CORESETs and/or Search Spaces on a DL BWP (e.g., the active DL BWP on each activated serving cell or the initial BWP on a camped cell) configured with PDCCH monitoring according to corresponding search space sets, wherein the term “monitoring” implies decoding each PDCCH candidate according to the monitored DCI formats. That is, the DCI with cyclic redundancy check (CRC) bits scrambled by UE specific RNTI (e.g., C-RNTI) is carried by the PDCCH, and the UE may find DCI by descrambling the CRC bits with the RNTI.

CORESET and Search Space: As mentioned above, UE monitors PDCCH candidates within one or more CORESET, wherein a CORESET may be represented as a specific radio resource indicated by the gNB via one or more configuration (i.e., ControlResourceSet information element (IE)). The one or more configurations may be transmitted by the gNB to the UE via broadcast system information block (SIB) or dedicated (unicast) signaling. It is assumed that a CORESET having a particular width in frequency domain as well as a particular width in time domain which were indicated by the ControlResourceSet IE. In time domain, the CORESET may be periodically appeared (i.e., allocated by gNB). The exact positions of the CORESETs in time domain were preconfigured by the gNB to the UE through a SearchSpace IE. Each ControlResourceSet is indexed with a CORESET ID which carried by the ControlResourceSet IE itself. Similarly, each SearchSpace is indexed with a SearchSpace ID which carried by the SearchSpace IE itself. Meanwhile, for each of configured SearchSpaces IE, it will be associated with one ControlResourceSet IE which is indicated through the SearchSpaces IE. Hence, by providing the associated ControlResourceSet IE and SearchSpaces IE to UE, gNB indicates the CORESET to UE for PDCCH monitoring.

Each search space may be further be categorized as CSS or USS which is indicated by the gNB to the UE via corresponding SearchSpace. UE may be indicated with multiple of search spaces, each may be applied by the gNB for different purposes. For example, a SearchSpace for a purpose of random access or a SearchSpace for a purpose of normal data transmission/reception assignment.

RRC Configuration for MBS: According to the service requirement for MBS, NR may at least support two transmission modes which may be applied by gNB to perform MBS data delivery, as listed below:

Point to Multipoint (PTM): gNB performs DL MBS data assignment via particular type of RNTI, and a single copy of DL data, which identified by the particular type of RNTI, will be received by a group of UE.

Point to Point (PTP): Similar as legacy unicast data transmission, the gNB perform DL MBS data assignment via UE specific RNTI (e.g., C-RNTI). And the scheduled data was solely monitor and received by a single UE.

It is noted that the implementation details of PTM and PTP may not limit to the example gives as above.

From the UE's protocol stack perspective in NR, a UE may be configured by a gNB with one or multiple of RLC bearers via downlink RRC signaling for supporting MBS service. It is noted that, an RLC bearer comprising an RLC entity and an associated logical channel (LCH). Each RLC bearer will be configured, by gNB, to be associated with a PDCP entity or a Radio Bearer (or we may say an MBS bearer). The MBS bearer may be defined as a radio bearer which associated with one MBS session (or TMGI) and/or associated with one MBS service. In addition, according to the definition addressed in 3GPP Technical Specification (TS) 38.321, a logical channel is offered by a Media Access Control (MAC) entity to an RLC entity. The LCH represents the service access point between the Media Access Control (MAC) entity and the Radio Link Control (RLC) entity.

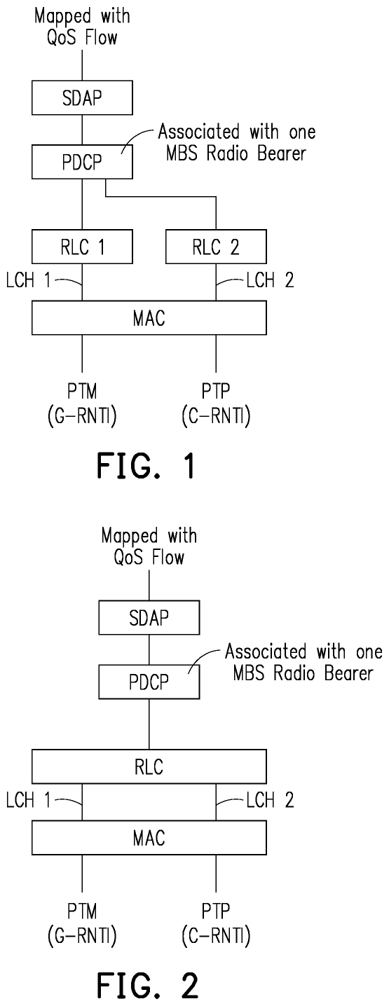

In either the PTM or PTP transmission mode, the present disclosure assumes that the UE may be configured with at least two RLC bearers (Separated RLC entities scheme). FIG. 1 illustrates a schematic diagram of protocol stack of UE for MBS configured with separated RLC entities according to an embodiment of the present disclosure. Each of the configured two RLC bearers having its own responsibility, for example, a first RLC bearer (i.e., RLC 1) may be configured for handling point to multipoint (PTM) reception and a second RLC bearer (i.e., RLC 2) may be configured for handling point to point (PTP) reception. It is noted that, both of the first and the second RLC bears may be associated with a common PDCP entity and a common MAC entity. In some implementations, both first and the second RLC bears may be associated with a common PDCP entity, but the first RLC bearer and the second RLC bearer may be associated with different MAC entities (e.g., MCG MAC and SCG MAC), wherein the PDCP entity may be associated with an MBS bearer, the LCH 1 belongs to the first RLC bearer, and the LCH 2 belongs to the second RLC bearer.

It is also assumed that the PTM transmission may be achieved (scheduled) by gNB via a group (shared) RNTI (e.g., G-RNTI) and the PTP transmission may be achieved (scheduled) by gNB via a UE specific RNTI (e.g., C-RNTI). It is noted that, a group RNTI may be (pre)configured by the gNB and the group RNTI may be associated with an MBS bearer (or an MBS session, or TMGI). For example, a gNB may transmit an RRC message to a UE, wherein the RRC message may indicate a group RNTI associated with an MBS bearer. In one implementation, a UE may be configured with multiple of MBS bearers and each of the MBS bearers may be associated with a group RNTI, wherein the group RNTI (e.g., G-RNTI) is configured by the gNB. For example, two MBS bearers may share a group RNTI. For another example, two MBS bearers may be associated with different group RNTIs. A group RNTI may be shared/applied by one or multiple UEs which are configured with the same MBS. For simplicity presentation in the present disclosure, it is noted that, the “associated with one MBS bearer” may be interpreted as “associated with one MBS”, “associated with one MBS service”, or “associated with one MBS application”. Furthermore, the “monitor PDCCH for DCI with CRC bits scrambled by the G-RNTI/C-RNTI” may be interpreted as “monitor G-RNTI/C-RNTI on the PDCCH” in the present disclosure.

Depending on whether the two configured RLC bearers shares a common RLC entity or not, another example of implementation for protocol stack of UE for MBS which sharing a common RLC entity is shown as in FIG. 2. As shown in FIG. 2, a UE may be configured with two RLC bearers: a first RLC bearer and a second RLC bearer, wherein the first RLC bearer and the second RLC bearer may share a common RLC entity.

DL data assignment for MBS:

As mentioned above, the MBS may support at least two transmission modes: PTP and PTM. The definition and corresponding detail of the PTP and PTM transmission modes are further specified as the following:

PTP transmission: For RRC_CONNECTED UEs, a DCI may include CRC bits scrambled by a UE-specific RNTI (e.g., C-RNTI) and the DCI may be transmitted on UE-specific PDCCH to schedule UE-specific PDSCH reception, wherein the UE-specific PDCCH may be scrambled with the same UE-specific RNTI.

Depends on the type of RNTI applied for an assignment for PDSCH reception, the PTM may be categorized into two schemes:

PTM transmission scheme I: For RRC_CONNECTED UEs in the same MBS group, the gNB may apply a DCI including CRC bits scrambled by a group-common RNTI (e.g., G-RNTI) and the DCI may be transmitted on group-common PDCCH to schedule group-common PDSCH reception, wherein the group-common PDCCH may be scrambled with the same group-common RNTI. This scheme can also be named as group-common PDCCH based group scheduling scheme.

PTM transmission scheme II: For RRC_CONNECTED UEs in the same MBS group, the gNB may apply a DCI including CRC bits scrambled by a UE-specific RNTI (e.g., C-RNTI) and the DCI may be transmitted on UE-specific PDCCH to schedule group-common PDSCH reception, wherein the UE-specific PDCCH may be scrambled with a group-common RNTI. This scheme can also be named as UE-specific PDCCH based group scheduling scheme. In one implementation, the DCI may include an indication which indicates that the scheduled PDSCH is scrambled with a group-common RNTI (e.g., G-RNTI).

The indication may be carried via an explicit DCI field or via specific information carried in other DCI fields. For example, UE may determine the scheduled PDSCH is scrambled with a group-common RNTI if the frequency resource allocated for the PDSCH is within a BWP (or Common frequency resource) specifically for PDSCH scrambled with group-common RNTI. For another example, UE may determine the scheduled PDSCH is scrambled with a group-common RNTI if a field of the DCI indicates the group-common RNTI, wherein the field may include an index to a list of one or more group common RNTI. It is noted that, the list may also include a C-RNTI.

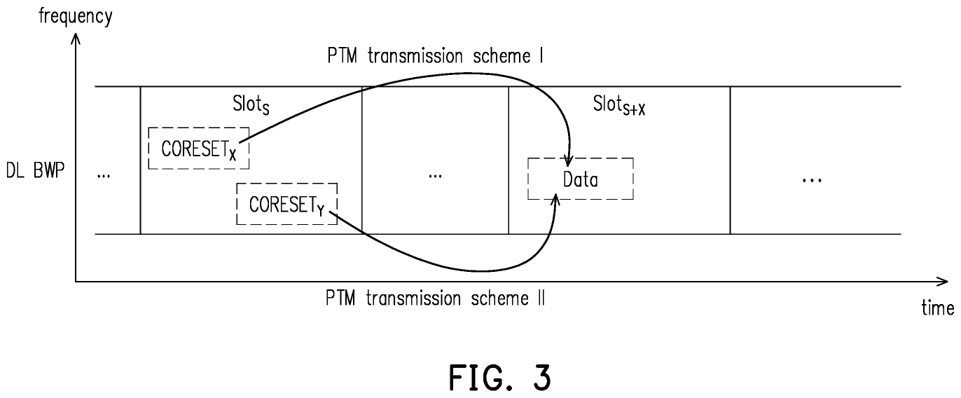

FIG. 3 illustrates a schematic diagram of PTM transmission schemes according to an embodiment of the present disclosure. As shown in FIG. 3, the UE may be configured by gNB to monitor PDCCH on two control resource sets (CORESETs), CORESET_{X} and CORESET_{Y} in slot_{S}. It is noted that, in NR, the PDCCH monitoring on CORESET may be configured by RRC via particular CORESET configuration (either received by the UE from system information block (SIB1) or DL RRC signaling), wherein the CORESET configuration may be implemented at least by the following example.

In one example as shown in FIG. 3, the CORESET_{X} may be configured by the gNB for monitoring the group-common PDCCH and the CORESET_{Y} may be configured by the gNB for monitoring the UE-specific PDCCH, respectively. Per the definitions of the two PTM transmission schemes as addressed above, both of the CORESET_{X} and CORESET_{Y} may be applied by the gNB for scheduling a group-common PDSCH reception (i.e., data box addressed in slot_{S+X}). That is, in PTM transmission scheme I, the gNB may transmit a DCI with CRC bits scrambled by the G-RNTI on the group-common PDCCH within CORESET_{X} for scheduling a group-common PDSCH reception in slot_{S+K}. On the other hand, in PTM transmission scheme II, the gNB may transmit a DCI with CRC bits scrambled by the C-RNTI on the UE-specific PDCCH within CORESET_{Y} for scheduling a group-common PDSCH reception in slot_{S+K}.

It is also noted that, a UE-specific PDCCH/PDSCH means the PDCCH/PDSCH can only be identified by a target UE but cannot be identified by the other UEs in the same MBS group with the target UE. A group-common PDCCH/PDSCH means the PDCCH/PDSCH can be transmitted on the same time/frequency resources and can be identified by all the UEs in the same MBS group. In the present disclosure, an MBS group may be referred to as a group of more than one UE that is (interested in) receiving the same MBS service. Alternatively, an MBS group may be referred to one or more multicast/broadcast services, wherein the one or more multicast/broadcast services may have similar data arrival time/burst and may be scheduled together by using the same CORESET.

In another example as shown in FIG. 3, the CORESET_{X} configured for monitoring the group-common PDCCH and the CORESET_{Y} configured for monitoring the UE-specific PDCCH may allocated in different bandwidth parts (BWPs) and/or serving cells. Hence, some BWP switching behavior may be happened upon the transmission scheme is switched. Some cell activation/deactivation behavior may also happen upon the transmission scheme is switched.

In one implementation of the PTM transmission scheme II, a single (group-common) PDSCH may carry data for both first RLC bearer and the second RLC bearer at the same time. That is, a transport block received on a (group-common) PDSCH may contain the MAC SDU(s) for LCH of RLC bearer for PTM and may contain the MAC SDU(s) for LCH of RLC bearer for PTP. The MAC SDU(s) for LCH of RLC bearer of PTM (i.e., MAC SDU(s) for PTM) and the MAC SDU(s) for LCH of RLC bearer of PTP (i.e., MAC SDU(s) for PTP) are differentiated by the MAC entity via a LCID field of a MAC sub-header of the MAC SDU. In gNB, the gNB may multiplex the MAC SDU for PTM and MAC SDU for PTP in a single MAC PDU, wherein the single MAC PDU may be scheduled by the UE-specific RNTI/C-RNTI.

HARQ process modelling for unicast: the MBS data transmission modes may support HARQ retransmission on above of HARQ processing mechanism built in the MAC entity and PHY layer. The HARQ retransmission may be (but not limited to be) triggered by gNB based on the received HARQ-ACK signaling feedback from the UE. It is noted that, the HARQ-ACK feedback here for NR is just a terminology represents UE performs feedback for a status of particular DL data reception and decoding. That is, during the HARQ-ACK feedback, the UE may either transmit ACK or NACK. For example, once the UE successfully received and decoded the DL data, the UE may transmit ACK during HARQ-ACK feedback, otherwise UE may transmit NACK during HARQ-ACK feedback for the failure of data reception and decoding.

The HARQ process modeling for MBS may be designed based on the mechanism for unicast DL data. Before going to details, a basic model of HARQ processing for unicast DL data reception is introduced as following. Firstly, UE may monitor PDCCH candidates according to gNB's configuration. A downlink assignment may be received on the PDCCH by the UE. Specifically, a UE's specific DCI (i.e., with CRC scrambled by the UE's specific RNTI such as C-RNTI) may be decoded by the UE on PDCCH. The MAC entity of the UE will be indicated by PHY the reception of the downlink assignment on the PDCCH. In PDSCH reception assignment (i.e., indicated by the DL assignment), HARQ information including a new data indicator (NDI) will be delivered from the PHY to the MAC entity, wherein the NDI may be an information field carried by the received DCI. Then, the MAC entity may evaluate the purpose and the type of the DL assignment, wherein the purpose and type evaluation mentioned may represents that the MAC entity evaluates whether the downlink assignment is for MAC entity's C-RNTI and/or whether the NDI have been toggled or not.

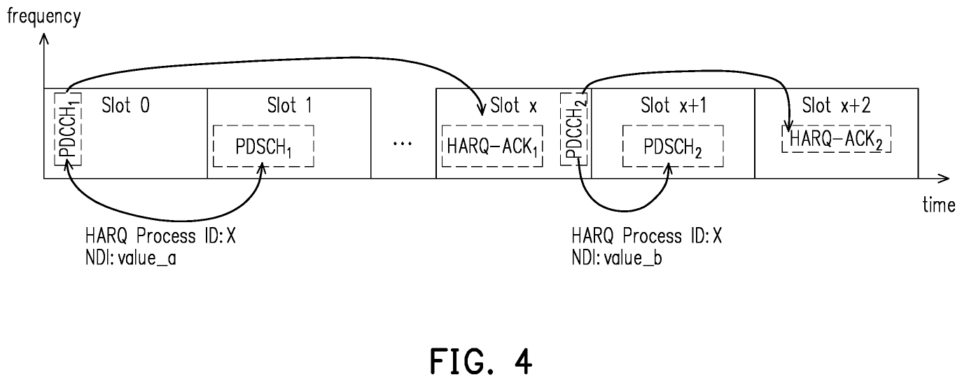

FIG. 4 illustrates a schematic diagram of HARQ process according to an embodiment of the present disclosure. As shown in FIG. 4, a UE may receive a DCI₂ (not shown in FIG. 4) on PDCCH₂ from a gNB within slot x, wherein the DCI₂ may schedule a PDSCH₂ reception and an uplink resource for corresponding HARQ-ACK₂ feedback on slot x+1 and slot x+2 respectively. Within the DCI₂, the UE may be indicated with a HARQ process ID (i.e., X) as well as an NDI value (i.e., value_b), wherein the HARQ process X may be indicated by the gNB for handling corresponding data reception of PDSCH₂. It is noted that, the HARQ process X may be assigned by the gNB, via a DCI₁ (not shown in FIG. 4) received on PDCCH₁, for another PDSCH reception (i.e., PDSCH₁) in slot 1 earlier than PDCCH₂. The DCI₁ may indicate an NDI value (i.e., value_a). Regarding the reception of PDCCH₂, the UE may evaluate whether the NDI value have been toggled or not by comparing value_b with value_a. It is noted that, in one implementation, the NDI may either be set to “0” or set to “1”. The NDI have been toggled means that value_b is different than value_a. For example, the value_b and value_a may either be “0 and 1” or “1 and 0” respectively. After the evaluation, once the NDI of DCI₂ is considered as toggled, the PDSCH₂ is considered as a new/initial transmission. On the contrary, once the NDI of DCI₂ is considered as non-toggled, the PDSCH₂ is considered as a retransmission (e.g., a retransmission of PDSCH₁).

Continue with the basic model of HARQ processing, the MAC entity may indicate the presence of the DL assignment and may deliver the HARQ information to the HARQ entity. It is noted that, the TB received on the PDSCH may be delivered from the PHY to the MAC entity at a time after the PDSCH reception (i.e., the end of the PDSCH in time domain). The MAC entity may allocate the TB and the HARQ information to a HARQ process indicated by the HARQ information. The HARQ process may evaluate whether the NDI has been toggled and if the DL assignment is a new transmission, and the MAC may attempt (i.e., instruct the PHY) to decode the received data. However, if the DL assignment is a retransmission and if the data has not yet been successfully decoded, the MAC entity may instruct the PHY to combine the received data with the data currently in the soft buffer for this TB and then attempt to decode the combined data. Per the MAC entity's instruction, the PHY may decode the received data and feedback the decoded result to the MAC entity.

If the data was successfully decoded, the MAC entity may deliver the decoded MAC PDU to a disassembly and demultiplexing entity and instruct the physical layer to generate acknowledgement(s) of the data in this TB. The MAC entity may instruct PHY to perform HARQ-ACK feedback. If the data was not successfully decoded, the MAC entity may instruct the PHY to replace the data in the soft buffer with the data which the MAC entity attempt to decode. After that, the MAC entity may instruct the physical layer to generate acknowledgement(s) of the data in this TB. The MAC entity may instruct PHY to perform HARQ-ACK feedback.

Component of HARQ process modeling for MBS: Obviously, since MBS data delivery via PTM transmission mode may be received by a group of UEs, it is possible that not all the UEs within the group can receive the data successfully. Depending on radio condition for each UE and some other situations, there may be few UEs within the group were failed on an MBS data reception while remaining UEs were succeeded. Without performing the HARQ-ACK feedback, it is challengeable for the gNB to understand the MBS data reception situation (i.e., whether all of the UE receives data well) in real time. If a proper HARQ-ACK feedback mechanism can be introduced for MBS data reception transmitted by PTM transmission mode, gNB may properly adjust modulation coding rate and/or performing corresponding retransmission either via PTM or PTP transmission mode. For example, once a UE within the group failed on an MBS data reception via PTM, the gNB may schedule a DL assignment for corresponding MBS data retransmission via PTP. If gNB would like to let the UE handle the retransmitted data by a same HARQ process as which handled the initial transmitted data, the gNB may indicates UE a same HARQ process ID to the UE for both of the initial transmission via PTM and the retransmission via PTP. In legacy, once a UE receives a DL assignment with a HARQ ID indication and an NDI, the UE should check whether the NDI of the HARQ ID have been toggled or not for determine whether the DL assignment corresponds to an initial transmission or a retransmission.

However, in case of MBS service with PTP and PTM as mention above, there exist some cases which may bring challenges to gNB on indicating initial transmission or retransmission via NDI. For example, assuming that a gNB performs a first DL assignment with PTP and a second DL assignment with PTM to a first UE, wherein the second DL assignment is later than the first assignment. Both of the first and second DL assignments are indicated to be handled by HARQ process x. If the second DL assignment is with PTM (scheme I), and an NDI of the second DL assignment may be received by a second UE which monitors the same MBS service as the first UE does, it is not proper for the gNB to indicate the initial transmission or retransmission via the NDI. It is because the HARQ process x may be applied by the second UE for PTM previously and corresponding NDI may not sync with the first UE. Hence, it is better for UE to determine whether received data corresponds to an initial transmission or a retransmission by some other ways. For example, the UE may determine whether a second DL assignment associated with the HARQ process x is an initial transmission or a retransmission by at least additionally considering the transmission mode (e.g., PTP or PTM) of the first DL assignment and the transmission mode of a second DL assignment. In other word, once a UE receives a DL assignment with a HARQ process, the UE may determine the DL assignment was for an initial transmission or a retransmission by at least base checking the HARQ process was previously indicated to be applied for a data transmitted by PTM or a data transmitted by PTP. In another implementation, once a UE receives a DL assignment with a HARQ process, the UE may determine the DL assignment was for an initial transmission or a retransmission by at least checking the HARQ process was previously indicated to be applied for a data scheduled by a UE specific RNTI (e.g., C-RNTI) or by a shared RNTI (e.g., G-RNTI).

Once gNB dynamically switch (or change) the transmission mode for MBS data transmission, it brings significant challenge and complexity on how gNB indicates UE each scheduled DL data reception is an initial transmission or is a retransmission properly. To introduce the present disclosure thoroughly, we describe details based on a scenario of UE sequentially receive two DL assignments, a first DL assignment and a second DL assignment. It is assumed that the second DL assignment occurs after first DL assignment in time domain, and both of the two DL assignments are associated with same MBS bearer/QoS flow. It is also assumed that, both of the two DL assignment were indicated to associated with (be handled by) the same HARQ process. It is note that, in the present disclosure, a DL assignment (on PDCCH) with a specific transmission mode (i.e., PTP or PTM) means the gNB performs the DL assignment to UE, and a DL data (on PDSCH) associated with the DL assignment was transmitted via the specific transmission mode. However, the transmission mode of PTM may be categorized into two transmission modes: PTM scheme I and PTM scheme II. The DL assignment with PTM scheme I may be achieved by gNB transmits a DCI with CRC bits scrambled by a G-RNTI, and PTM scheme II may be achieved by gNB transmits a DCI with CRC bits scrambled by a C-RNTI. The DL assignment with PTP may be achieved by gNB transmits a DCI with CRC bits scrambled by a C-RNTI.

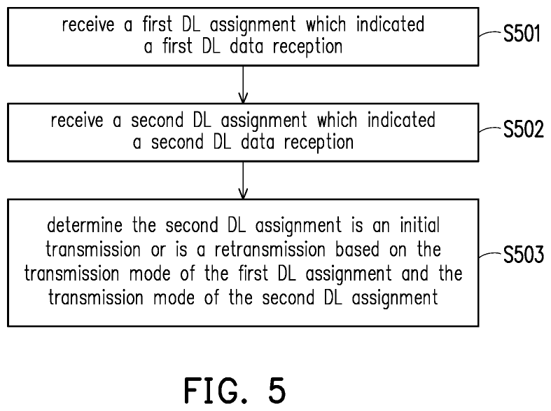

In one embodiment, as shown in FIG. 5, a UE may receive a first DL assignment which indicated a first DL data reception (step S501). After that, the UE may receive a second DL assignment which indicated a second DL data reception (step S502). The UE may determine the second DL assignment is an initial transmission or is a retransmission based on the transmission mode of the first DL assignment and the transmission mode of the second DL assignment (step S503). In one example, once a gNB finished some data retransmission (toward a UE) via PTP, the gNB may (explicitly/implicitly) switches the transmission mode (toward the UE) from PTP to PTM (i.e., first DL assignment with PTP transmission mode and second DL assignment with PTM transmission mode). In one example, the UE may determine the second DL assignment is an initial transmission since the work for retransmission via PTP is finished. In other words, the UE may determine the second DL assignment is an initial transmission since the transmission mode of the first DL assignment is with PTP.

In one embodiment, once a gNB finished some data retransmission (toward a UE) via PTP, the gNB may (explicitly/implicitly) switches the transmission mode (toward the UE) from PTP to PTM (i.e., first DL assignment with PTP transmission mode and second DL assignment with PTM transmission mode). The UE may determine the second DL assignment is an initial transmission since the work for retransmission via PTP is finished. In other words, the UE may determine the second DL assignment is an initial transmission since the transmission mode of the first DL assignment is with PTP.

In one embodiment, the UE may determine the second DL assignment is an initial transmission since the transmission mode of the first DL assignment is with a specific transmission mode (e.g., PTP) and the second DL assignment is with PTM.

In one embodiment, the UE may determine the second DL assignment is an initial transmission since the transmission mode of the first DL assignment is with a specific transmission mode (e.g., PTP) and the second DL assignment is with PTM scheme I. The different between this embodiment and the previous embodiment is, if the second DL assignment is with PTM scheme II (e.g., scheduled by C-RNTI), it is not challenging for the base station (e.g., a gNB) to indicate initial transmission or retransmission via NDI of the second DL assignment because the NDI of the second DL assignment may be the UE specific indication (i.e., the scheduling was achieved by UE specific type of RNTI such as C-RNTI). On the contrary, if the second DL assignment is with PTM scheme I (e.g., scheduled by G-RNTI), it is challenging for the based station (e.g., a gNB) to indicate initial transmission or retransmission via NDI of the second DL assignment because of the NDI of the second DL assignment may be common/shared by some other UEs.

In one embodiment, the UE may determine the second DL assignment is an initial transmission if the first DL assignment is achieved by transmitting a DCI with CRC bits scrambled by a C-RNTI, and the second DL assignment is achieved by transmitting a DCI with CRC bits scrambled by a G-RNTI.

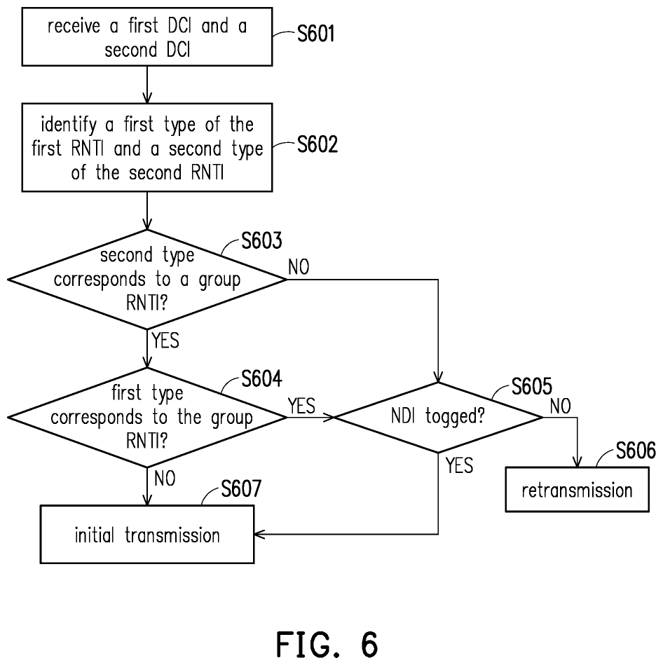

FIG. 6 illustrates a flowchart of a method of HARQ process for MBS according to an embodiment of the present disclosure. In step S601, the UE may receive a first DCI and a second DCI. Specifically, the UE may receive a first DCI on a first PDCCH scrambled by a first RNTI, wherein the first DCI may include a first NDI value and may schedule a first DL data reception corresponding to a HARQ process (e.g., HARQ process x) on a first PDSCH. After receiving the first DCI, the UE may receive a second DCI on a second PDCCH scrambled by a second RNTI, wherein the second DCI may include a second NDI value and may schedule a second DL data reception corresponding to the HARQ process (e.g., HARQ process x) on a second PDSCH.

In the following steps, the UE may determine the second DL assignment is associated with an initial transmission or is a retransmission based on the transmission mode of the first DL assignment and the transmission mode of the second DL assignment. Specifically, the UE may determine, according to the first type of the first RNTI and the second type of the second RNTI, whether the first NDI value and the second NDI value are used for determining the second DL data reception corresponds to the initial transmission or the retransmission of data packet(s) obtained from the first DL data reception.

In step S602, the UE may identify a first type of the first RNTI and a second type of the second RNTI, wherein the first type (or the second type) may include a UE specific RNTI (e.g., C-RNTI) or a group RNTI (e.g., G-RNTI).

In step S603, the UE may determine whether second type of the second RNTI corresponds to a group RNTI. If the second type of the second RNTI corresponds to a group RNTI, proceeding to step S604. If the second type of the second RNTI corresponds to a UE specific RNTI instead of a group RNTI, proceeding to step S605, the UE may determine the second DL data reception corresponds to the initial transmission or the retransmission by using the first NDI value and the second NDI value.

In step S604, the UE may determine whether the first type of the first RNTI corresponds to the group RNTI. If the first type of the first RNTI corresponds to the group RNTI, proceeding to step S605, the UE may determine the second DL data reception corresponds to the initial transmission or the retransmission by using the first NDI value and the second NDI value. If the first type of the first RNTI corresponds to a UE specific RNTI instead of the group RNTI, proceeding to step S607, the UE may determine the second DL data reception corresponds to the initial transmission or the retransmission without using the first NDI value and the second NDI value. In one embodiment, the group RNTI may be configured by a gNB to associated with a first transmission type (e.g., PTM transmission scheme I) for a group of UE and the UE specific RNTI may be configured by the gNB to associated with a second transmission type (e.g., PTP transmission or PTM transmission scheme II) for a single UE.

In step S605, the UE may determine the second DL data reception corresponds to the initial transmission or the retransmission by using the first NDI value and the second NDI value. Specifically, the UE may determine whether the second NDI is different from the first NDI. If the second NDI value is different from the first NDI value (i.e., NDI is togged), proceeding to step S607. If the second NDI value is the same as the first NDI value, proceeding to step S606.

In step S606, the UE may determine the second DL data reception corresponds to the retransmission of the data packet(s) obtained (by the UE) from the first DL data reception. In one embodiment, the UE may soft combine data received from the first DL data reception and the second DL data reception in response to determining the second DL data reception corresponds to the retransmission of the first DL data reception.

In step S607, the UE may determine the second DL data reception corresponds to the initial transmission. In one embodiment, the UE may decode data obtained from the second DL data reception in response to determining the second DL data reception corresponds to the initial transmission. The UE may flush a buffer corresponding to the HARQ process (e.g., HARQ process x) or may replace the data in the buffer by the data obtained from the second DL data reception. The UE may replace the old data packet (e.g., data packet obtained from the first DL data reception) in the buffer by the new data packet (e.g., data packet obtained from the second DL data reception).

Based on the component of HARQ process modeling for MBS mentioned above (e.g., as shown in FIG. 4), the present disclosure further addresses details for implementation. The HARQ processing for MBS may be based on few assumptions as below: (I) Within one serving cell, the total number of HARQ processes configured for MBS are limited. For example, a number of HARQ processes may be indicated by the gNB for MBS service; (II) The gNB may dynamically switch the transmission mode for an MBS bearer. Specifically, gNB may utilize either PTP or PTM transmission mode for MBS data transmission and may utilize different transmission modes for different MBS data. For example, gNB can perform an initial transmission via PTM and perform a corresponding retransmission via PTP, and versa vice.

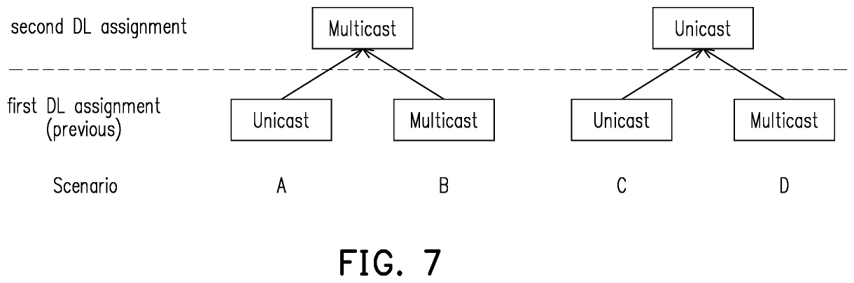

Once gNB dynamically switches (i.e., change) the transmission mode for MBS data transmission, it brings significant challenge and complexity on how gNB indicates UE each scheduled DL data reception is an initial transmission or is a retransmission properly. To introduce designs of the present disclosure thoroughly, details are described based on scenario of UE sequentially receive two DL assignments, first DL assignment and second DL assignment, wherein the second DL assignment occurs after first DL assignment in time domain, and both of the two DL assignments are associated with same MBS bearer/QoS flow. It is also assumed that both of the two DL assignment were indicated to be associated with (be handled by) the same HARQ process. Depending on each of the first and second DL assignment was with PTP or PTM transmission mode, there may be more combinations and bring more sub-scenarios as illustrated in FIG. 7 worth to be further designed and defined as following. It is note that, in present disclosure, a DL assignment (on PDCCH) with a specific transmission mode (i.e., PTP or PTM) means the gNB performs the DL assignment to UE and the DL data (on PDSCH) associated with the DL assignment was transmitted via the specific transmission mode. It is also noted that the DL assignment with PTM may be achieved by gNB transmits a DCI with CRC bits scrambled by a G-RNTI (e.g., via PTM transmission scheme I) or C-RNTI (e.g., via PTM transmission scheme II), and the DL assignment with PTP may be achieved by gNB transmits a DCI with CRC bits scrambled by a C-RNTI.

The details investigation on the scenarios as illustrated in FIG. 7 are described in the followings.

Scenario A: The second DL assignment with PTM. Firstly, a UE may receive a first DL assignment from the gNB. The first DL assignment may indicate the UE to perform a first DL data reception on PDSCH and may indicate the UE to handle the first DL data reception by a HARQ process x, wherein the first DL assignment may carry a first NDI. After the timing of the data reception of the first DL assignment, the UE may receive a second DL assignment with PTM from the gNB. The second DL assignment may indicate the UE to perform a second DL data reception on PDSCH and may indicate the UE to handle the second DL data reception by the HARQ process x, wherein the second DL assignment may carry a second NDI. In scenario A, once the UE receives the second DL assignment, the UE may determine the second DL assignment is an initial transmission if the first DL assignment was with PTP. That is, the UE may ignore the second NDI on the determination of whether the second DL assignment is an initial transmission or a retransmission. In other words, the MAC entity of the UE may always consider the NDI value for HARQ process x to have been toggled regardless of the value of the NDI.

It is noted that, under the assumption of the Scenario A, there may exist more sub-scenarios. For example, once the UE receives the second DL assignment, the UE may determine the second DL assignment is an initial transmission if the first DL assignment was with PTP, and the second DL assignment is with PTM scheme I. In contrast, if the first DL assignment was with PTP and the second DL assignment is with PTM scheme II, the UE may determine the second DL assignment is an initial transmission or is a retransmission based on whether the second NDI have been toggled by comparing to the first NDI. Once the second NDI have been toggled, the US may determine the second DL assignment is an initial transmission, otherwise the UE may determine second DL assignment is a retransmission. For one example, if the second DL assignment is with PTM scheme II, the UE may determine the second DL assignment is an initial transmission if the Modulation Coding Scheme (MCS) in the second DL assignment indicates a MCS index with a target code rate or a spectral efficiency. For one example, if the second DL assignment is with PTM scheme II, the UE may determine the PDSCH scheduled by the second DL assignment is an initial transmission if UE had transmitted HARQ-ACK feedback carrying ACK for the PDSCH scheduled by the first DL assignment. It is noted that, the UE may ignore a second DL assignment with PTM scheme 2 if UE determines the second DL assignment is not an initial transmission.

It is noted that, in each of Scenarios, a DL assignment with PTP or a DL assignment with PTM scheme II may be determined by the UE if the DCI of the DL assignment is with CRC bits scrambled by a C-RNTI. A DL assignment with PTM scheme I may be determined by the UE if the DCI of the DL assignment is with CRC bits scrambled by a G-RNTI.

In one implementation, a UE may allocate each MBS service one or more HARQ process IDs. In addition, the mapping between a service and its corresponding HARQ process IDs may be provided by the network via broadcast system information (e.g., SIB) and/or dedicated signaling (e.g., dedicated RRC signaling). Moreover, the HARQ process IDs of different services may or may not overlap to each other.

In one implementation, the DCI of the second DL assignment may contain a field which explicitly indicate the data is initial transmission or retransmission.

Scenario B: The second DL assignment with PTM and the first DL assignment is also with PTM. Firstly, a UE may receive a first DL assignment from the gNB. The first DL assignment may indicate the UE to perform a first DL data reception on PDSCH and may indicate the UE to handle the first DL data reception by a HARQ process x, wherein the first DL assignment may carry a first NDI. After the timing of the data reception of first DL assignment, the UE may receive a second DL assignment with PTM from the gNB. The second DL assignment may indicate the UE to perform a second DL data reception on PDSCH and may indicate the UE to handle the second DL data reception by the HARQ process x, wherein the second DL assignment may carry a second NDI. In scenario B, once the UE receives the second DL assignment, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission.

It is noted that, under the assumption of the Scenario B, there may exist more sub-scenarios. For example, once the UE receives the second DL assignment, the UE may determine the second DL assignment is an initial transmission if the first DL assignment was with PTM scheme II, and the second DL assignment is with PTM scheme I. In one example, if the first DL assignment was with PTM scheme II and the second DL assignment is with PTM scheme II, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission. In one example, if the first DL assignment was with PTM scheme I and the second DL assignment is with PTM scheme II, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission. In one example, if the first DL assignment was with PTM scheme I and the second DL assignment is with PTM scheme I, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission.

Scenario C: The second DL assignment with PTP and the first DL assignment is also with PTP. Firstly, a UE may receive a first DL assignment from the gNB. The first DL assignment may indicate the UE to perform a first DL data reception on PDSCH and may indicate the UE to handle the first DL data reception by a HARQ process x, wherein the first DL assignment, may carry a first NDI. After the timing of the data reception of first DL assignment, the UE may receive a second DL assignment with PTP from the gNB. The second DL assignment may indicate the UE to perform a second DL data reception on PDSCH and may indicate the UE to handle the second DL data reception by the HARQ process x, wherein the second DL assignment may carry a second NDI. In scenario C, once the UE receives the second DL assignment, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission.

Scenario D: The second DL assignment with PTP and the first DL assignment with PTM. Firstly, a UE may receive a first DL assignment from the gNB. The first DL assignment may indicate the UE to perform a first DL data reception on PDSCH and may indicate the UE to handle the first DL data reception by a HARQ process x, wherein the first DL assignment may carry a first NDI. After the timing of the data reception of first DL assignment, the UE may receive a second DL assignment with PTP from the gNB. The second DL assignment may indicate the UE to perform a second DL data reception on PDSCH and may indicate the UE to handle the second DL data reception by the HARQ process x, wherein the second DL assignment may carry a second NDI. In scenario D, once the UE receives the second DL assignment, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission.

It is noted that all the designs addressed above, may be limited to the assumption that the first and the second DL assignments are associated with same MBS service/bearer.

HARQ process modeling for MBS with individual HARQ ID pool: The details of HARQ processing for MBS may have more differences if assumptions as below are introduced.

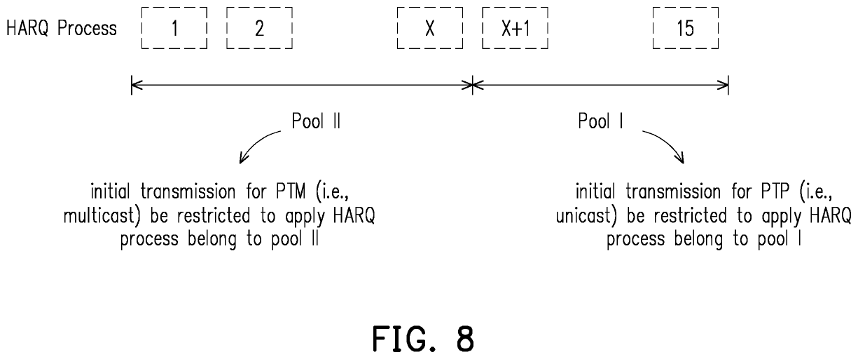

(III) The initial transmission for PTP (i.e., unicast) and initial transmission for PTM (i.e., multicast) may be restricted to apply HARQ process belong to different HARQ process pools (i.e., a number of HARQ processes) individually as illustrated in FIG. 8. That is, the initial transmission for PTP and initial transmission for PTM are restricted to be handled by different HARQ process(es). Once the gNB needs perform a DL assignment with PTP, the gNB is restricted to indicate UE the DL assignment is handle by any of HARQ process within a first HARQ process pool (i.e., pool I as shown in FIG. 8). Once, the gNB needs perform a DL assignment with PTM, the gNB is restricted to indicate UE the DL assignment is handled by any of HARQ process within a second HARQ process pool (i.e., pool II as shown in FIG. 8), wherein the second HARQ process pool is different from the first HARQ process pool.

As shown in FIG. 8, the UE may be configured with 15 HARQ processes. Process 1 to process X are belong to pool II and process X+1 to process 15 are belong to pool I. That is the any of configured HARQ process may belong to either the first or the second HARQ process pool. In one example, there are total 15 HARQ processes (i.e., process 1 to process 15) are indicated to the UE by the gNB (either specific or not specific for MBS service), and the gNB may further indicate which of the 15 HARQ processes belong to the first HARQ process pool for initial transmission for PTP. In addition, the gNB may indicate which of the 15 HARQ processes belong to the second HARQ process pool for initial transmission for PTM. It is noted that, any of the HARQ process belong to the first HARQ process pool is allowed for the gNB to indicate UE to apply for handling DL assignment with PTP for a retransmission as well as to apply for handing DL assignment with PTM for a retransmission. On the other hand, any of HARQ process belong to the second HARQ process pool is allowed for the gNB to indicate UE to apply for handling DL assignment with PTM for a retransmission as well as to apply for handing DL assignment with PTP for a retransmission.

Continue with the assumption III as disclosed above, regarding how the gNB indicates, each of a plurality of HARQ processes for MBS may be reserved for performing an initial transmission via PTP or PTM. Some implementations are described below. It is noted that, it is possible that the gNB does not reserved a number of HARQ processes for MBS, but the gNB may indicate the UE which of HARQ processes configured to the UE is/are reserved for performing an initial transmission via PTP or PTM.

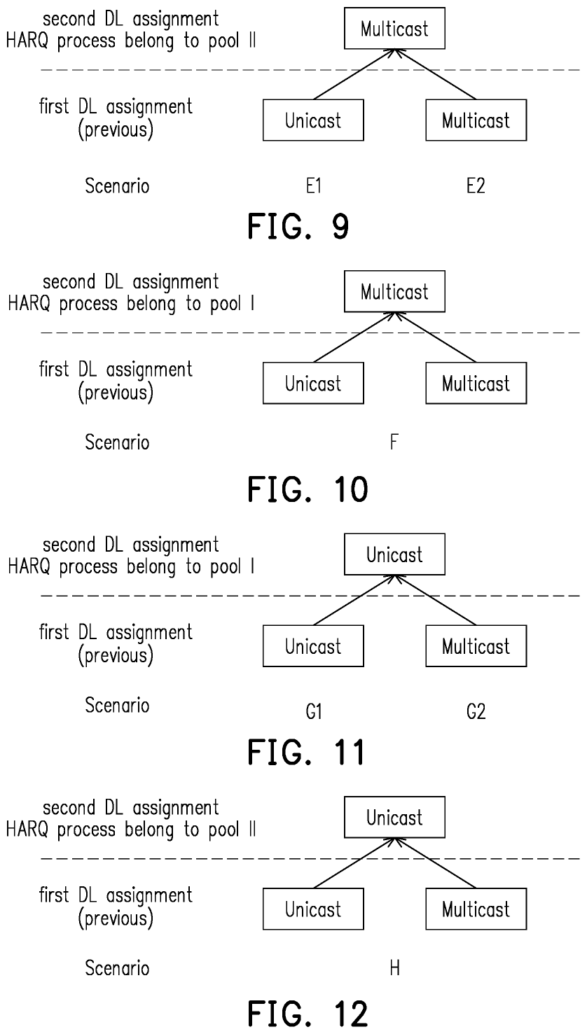

Under the Assumption III mentioned above, more combination of scenarios may be introduced as shown in FIGS. 9, 10, 11, and 12.

Scenario E1: As shown in FIG. 9, the second DL assignment with PTM and the first DL assignment with PTP. Firstly, a UE may receive a first DL assignment from the gNB. The first DL assignment may indicate the UE to perform a first DL data reception on PDSCH and may indicate the UE to handle the first DL data reception by a HARQ process x, wherein the first DL assignment may carry a first NDI. After the timing of the data reception of first DL assignment, the UE may receive a second DL assignment with PTM from the gNB. The second DL assignment may indicate the UE to perform a second DL data reception on PDSCH and may indicate the UE to handle the second DL data reception by the HARQ process x, wherein the second DL assignment may carry a second NDI. The HARQ process x belongs to the HARQ process pool II as shown in FIG. 8. In scenario E1, once the UE receives the second DL assignment, the UE may determine the second DL assignment is an initial transmission if the first DL assignment was with PTP. That is, the UE may ignore the second NDI on the determination of whether the second DL assignment is an initial transmission or a retransmission. In other words, the MAC entity of the UE may always consider the NDI value for HARQ process x to have been toggled regardless of the value of the NDI.

It is noted that, under the assumption of the Scenario E1, there may exist more sub-scenarios similar as addressed for Scenario A. For example, once the UE receives the second DL assignment, the UE may determine the second DL assignment is an initial transmission if the first DL assignment was with PTP, and the second DL assignment is with PTM scheme I. In contrast, if the first DL assignment was with PTP and the second DL assignment is with PTM scheme II, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission.

Scenario E2: As shown in FIG. 9, the second DL assignment with PTM and the first DL assignment is also with PTM. Firstly, a UE may receive a first DL assignment from the gNB. The first DL assignment may indicate the UE to perform a first DL data reception on PDSCH and may indicate the UE to handle the first DL data reception by a HARQ process x, wherein the first DL assignment may carry a first NDI. After the timing of the data reception of first DL assignment, the UE may receive a second DL assignment with PTM from the gNB. The second DL assignment may indicate the UE to perform a second DL data reception on PDSCH and may indicates the UE to handle the second DL data reception by the HARQ process x, wherein the second DL assignment may carry a second NDI. The HARQ process x belongs to the HARQ process pool II as shown in FIG. 8. In scenario E2, once the UE receives the second DL assignment, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission.

It is noted that, under the assumption of the Scenario E2, there may exist more sub-scenarios similar as addressed for Scenario B. For example, once the UE receives the second DL assignment, the UE may determine the second DL assignment is an initial transmission if the first DL assignment was with PTM scheme II, and the second DL assignment is with PTM scheme I. In one example, if the first DL assignment was with PTM scheme II and the second DL assignment is with PTM scheme II, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission. In one example, if the first DL assignment was with PTM scheme I and the second DL assignment is with PTM scheme II, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission. In one example, if the first DL assignment was with PTM scheme I and the second DL assignment is with PTM scheme I, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission.

Scenario F: As shown in FIG. 10, the second DL assignment with PTM. Firstly, a UE may receive a first DL assignment from the gNB (no matter the first DL assignment is with PTP or PTM). The first DL assignment may indicate the UE to perform a first DL data reception on PDSCH and may indicate the UE to handle the first DL data reception by a HARQ process x, wherein the first DL assignment may carry a first NDI. After the timing of the data reception of first DL assignment, the UE may receive a second DL assignment with PTM from the gNB. The second DL assignment may indicate the UE to perform a second DL data reception on PDSCH and may indicate the UE to handle the second DL data reception by the HARQ process x, wherein the second DL assignment may carry a second NDI. The HARQ process x belongs to the HARQ process pool I as shown in FIG. 8. In scenario F, once the UE receives the second DL assignment, the UE may determine the second DL assignment is a retransmission since second DL assignment is with PTM and the HARQ process x belongs to the HARQ process pool I. Accordingly, the only possibility of the second DL assignment is either a retransmission based on PTP or a retransmission based on PTM.

Scenario G1: As shown in FIG. 11, the second DL assignment with PTP and the first DL assignment with PTP. Firstly, a UE may receive a first DL assignment from the gNB. The first DL assignment may indicate the UE to perform a first DL data reception on PDSCH and may indicate the UE to handle the first DL data reception by a HARQ process x, wherein the first DL assignment may carry a first NDI. After the timing of the data reception of first DL assignment, the UE may receive a second DL assignment with PTP from the gNB. The second DL assignment may indicate the UE to perform a second DL data reception on PDSCH and may indicate the UE to handle the second DL data reception by the HARQ process x, wherein the second DL assignment may carry a second NDI. The HARQ process x belongs to the HARQ process pool I as shown in FIG. 8. In scenario G1, once the UE receives the second DL assignment, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission.

Scenario G2: As shown in FIG. 11, the second DL assignment with PTP and the first DL assignment with PTM. Firstly, a UE may receive a first DL assignment from the gNB. The first DL assignment may indicate the UE to perform a first DL data reception on PDSCH and may indicate the UE to handle the first DL data reception by a HARQ process x, wherein the first DL assignment may carry a first NDI. After the timing of the data reception of first DL assignment, the UE may receive a second DL assignment with PTP from the gNB. The second DL assignment may indicate the UE to perform a second DL data reception on PDSCH and may indicate the UE to handle the second DL data reception by the HARQ process x, wherein the second DL assignment may carry a second NDI. The HARQ process x belongs to the HARQ process pool I as shown in FIG. 8. In scenario G2, once the UE receives the second DL assignment, the UE may determine the second DL assignment is an initial transmission or is a retransmission based on whether the second NDI have been toggled by comparing to the first NDI. Once the second NDI have been toggled, the UE may determine the second DL assignment is an initial transmission, otherwise the UE may determine the second DL assignment is a retransmission.

Scenario H: As shown in FIG. 12, the second DL assignment with PTP. Firstly, a UE may receive a first DL assignment from the gNB (a.k.a. no matter the first DL assignment is with PTP or PTM). The first DL assignment may indicate the UE to perform a first DL data reception on PDSCH and may indicate the UE to handle the first DL data reception by a HARQ process x, wherein the first DL assignment may carry a first NDI. After the timing of the data reception of first DL assignment, the UE may receive a second DL assignment with PTP from the gNB. The second DL assignment may indicate the UE to perform a second DL data reception on PDSCH and may indicate the UE to handle the second DL data reception by the HARQ process x, wherein the second DL assignment may carry a second NDI. The HARQ process x belongs to the HARQ process pool II as shown in FIG. 8. In scenario H, once the UE receives the second DL assignment, the UE may determine the second DL assignment is a retransmission since second DL assignment is with PTP and the HARQ process x belongs to the HARQ process pool II. Accordingly, the only possibility of the second DL assignment is either a retransmission based PTM or a retransmission based on PTP.

It is noted that all the designs addressed above, may be limited to the assumption that the first and the second DL assignments are associated with same MBS service/bearer.

Other approaches of HARQ process modeling for MBS are described below.

In one implementation, the MBS service may have some predefined rules. For example, the PTM scheme I may only be applied by the gNB for initial transmission. Accordingly, once the UE receives a DL assignment with PTM scheme I, the UE may always determine the DL data of the DL assignment is an initial transmission regardless of previous DL assignment with same HARQ process. Once HARQ feedback for data transmitted via PTM scheme I is supported in NR, the gNB may perform corresponding data retransmission via PTP only.

In one implementation, the MBS service may have some predefined rules. For example, the PTM scheme I may only be applied by the gNB for initial transmission and the PTP scheme may only be applied by the gNB for retransmission.

In one implementation, the MBS service may have some predefined rules. For example, the PTM scheme I may only be applied by the gNB for initial transmission and the PTP scheme may only be applied by the gNB for retransmission. The UE may be configured with two HARQ process pool: HARQ pool I and HARQ pool II as shown in FIG. 8. MBS PTM scheme I and PTP scheme may be restricted to apply HARQ process belongs to the HARQ pool I, and MBS scheme II may be restricted to apply HARQ process belongs to the HARQ pool II. Accordingly, assuming that the gNB indicates the UE to handle the DL assignment by a HARQ process x. If the UE receives a DL assignment by a DCI with CRC bits scrambled by C-RNTI (which means the DL assignment may be PTM scheme II or PTP), the UE may determine the DL assignment is an initial transmission, regardless of whether NDI is toggled or not if the HARQ process x belongs to pool I. On the other hand, in case of the HARQ process x belonging to pool II, the UE may determine the DL assignment is a retransmission regardless of whether NDI is toggled or not.

It is noted that all the designs addressed above, may be limited to the assumption that the first and the second DL assignments are associated with same MBS service/bearer.

MBS transmission mode switching: On an objective of keeping MBS service continuity and lossless data transmission/reception, dynamic switch between the two transmission modes (i.e., PTM and PTP) may be a key characteristic. That is, the gNB should have flexibility to decide whether to deliver a user plane data packet through PTM to a group of UEs or through PTP for any specific UE. The decision for selection of PTM and PTP (i.e., multicast and unicast) for packet delivery may be based on a number of matters. For example, based on number of UEs interested to receive a given multicast service or based on radio channel conditions of UEs.

The notification of transmission scheme switch may be achieved by receiving corresponding indicator from gNB, and the indicator may be implemented as one or multiple alternative details listed as below:

(1). A DCI field and/or DCI format explicitly indicating transmission scheme.

(2). The UE is pre-configured with a default/initial transmission scheme, and the transmission scheme is changed while receiving an indicator indicating to change the transmission scheme. That is, an indicator indicating whether the transmission scheme is changed or not.

(3). The indicator is implicitly represented by the “HARQ process number” field of the DCI. For example, once the “HARQ process number” field indicates a valid value may interpreted as the data is for PTP transmission scheme. On the other hand, if the “HARQ process number” field indicates an invalid value may interpreted as the data is for PTM transmission scheme.

(4). The indicator is implicitly represented by frequency domain resource allocation. For example, UE may determine a scheduled PDSCH is transmitted with PTM transmission scheme if the frequency resource allocated for the PDSCH is within a BWP specifically for PDSCH with PTM transmission scheme.

(5). The indicator is implicitly represented by an indication related to initialization of a scrambling sequence for a PDSCH. For example, a UE may determine a scheduled PDSCH is transmitted with PTM transmission scheme if a field indicates the scrambling sequence for the PDSCH is initialized based on a group-common RNTI. It is noted that, the indication may be an index to a list of one or more group common RNTI, and the list may also include C-RNTI.

(6). A MAC CE explicitly indicating transmission scheme. It is noted that, since the UE may be configured with multiple of MBS bearer, each bit/field of the MAC CE may associate with one of MBS bearers in ascending/descending order of the bearer ID.

In some detail implementations, the UE may switch to PTP transmission scheme once one or more event listed as below is occurred:

(1). UE transmits a HARQ feedback in response to a PDSCH reception being scheduled by the gNB through G-RNTI (e.g., PTM transmission scheme I).

(2). UE transmits a HARQ feedback in response to a PDSCH reception being scheduled by the gNB through G-RNTI (e.g., PTM transmission scheme I), and the HARQ feedback indicating NACK.

(3). UE is scheduled by gNB with a PDSCH reception through PTM transmission scheme II. That is, a DCI is received, and the DCI with CRC bits scrambled by C-RNTI schedule group common PDSCH reception.

(4). UE receives a DCI with CRC bits scrambled by G-RNTI.

(5). UE receives a DCI with CRC bits scrambled by G-RNTI and the DCI indicates the scheduled PDSCH reception is new transmission.

(6). Once the UE is leave RRC_CONNECTED state, for example, the UE enter RRC IDLE or RRC INACTIVE state.

(7). Once a beam failure event is happened.

(8). Once a beam failure event is happened and the UE initiate a beam failure recovery procedure, wherein the beam failure recovery procedure may be a random access procedure and/or a procedure which the UE transmit failed beam and/or cell via uplink MAC control element (MAC CE).

(9). Once an indication is received from upper layer (e.g., RRC or PDCP).

In some detail implementations, the UE may switch to PTM transmission scheme once one or more event listed as below is occurred:

(1). UE transmits a HARQ feedback in response to a PDSCH reception being scheduled by the gNB through G-RNTI (e.g., PTM transmission scheme I).

(2). UE transmits a HARQ feedback in response to a PDSCH reception being scheduled by the gNB through G-RNTI (e.g., PTM transmission scheme I), and the HARQ feedback indicating NACK.

(3). UE is scheduled by gNB with a PDSCH reception through PTM transmission scheme I. That is, a DCI is received, and the DCI with CRC bits scrambled by G-RNTI schedule group common PDSCH reception.

(4). UE receives a DCI with CRC bits scrambled by G-RNTI.

(5). UE receives a DCI with CRC bits scrambled by G-RNTI and the DCI indicates the scheduled PDSCH reception is new transmission.

(6). An indication indicating the UE to activate the MBS service is received.

(7). Once the UE is leave RRC_CONNECTED state. For example, the UE enter RRC IDLE or RRC INACTIVE state.

(8). Once a beam failure event is happened.

(9). Once a beam failure event is happened and the UE initiate a beam failure recovery procedure, wherein the beam failure recovery procedure may be a random access procedure and/or a procedure which the UE transmit failed beam and/or cell via uplink MAC control element (MAC CE).

(10). Once an indication is received from upper layer (e.g., RRC or PDCP).

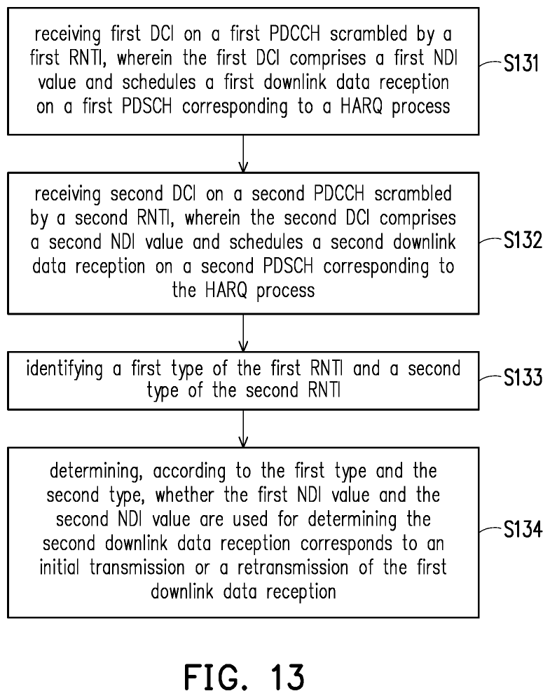

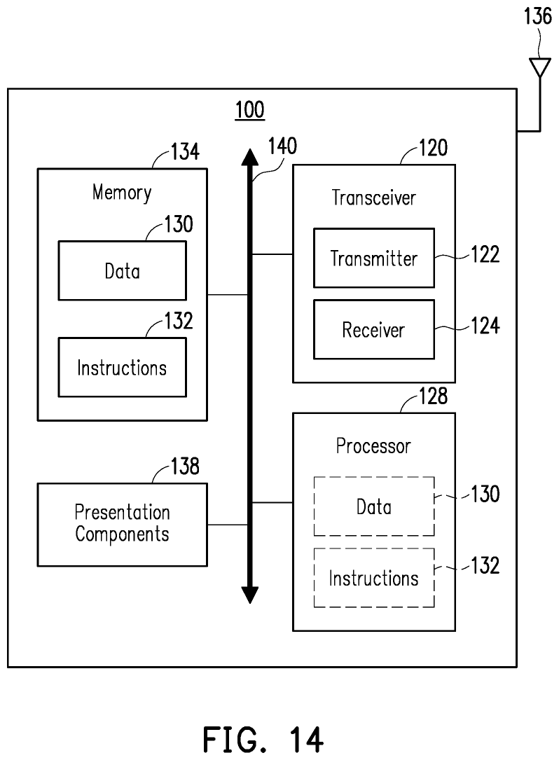

FIG. 13 illustrates a flowchart of a method of HARQ process for MBS according to an embodiment of the present disclosure, wherein the method may be adapted to a UE (e.g., UE 100 in FIG. 14). In step S131, receiving first downlink control information (DCI) on a first physical downlink control channel (PDCCH) scrambled by a first radio network temporary identifier (RNTI), wherein the first DCI comprises a first new data indicator (NDI) value and schedules a first downlink data reception on a first physical downlink shared channel (PDSCH) corresponding to a HARQ process. In step S132, receiving second DCI on a second PDCCH scrambled by a second RNTI, wherein the second DCI comprises a second NDI value and schedules a second downlink data reception on a second PDSCH corresponding to the HARQ process. In step S133, identifying a first type of the first RNTI and a second type of the second RNTI. In step S134, determining, according to the first type and the second type, whether the first NDI value and the second NDI value are used for determining the second downlink data reception corresponds to an initial transmission or a retransmission of the first downlink data reception.

FIG. 14 illustrates a block diagram of a node for wireless communication according to an embodiment of the present disclosure. As shown in FIG. 14, a node 100 may include a transceiver 120, a processor 128, a memory 134, one or more presentation components 138, and at least one antenna 136. The node 100 may also include an RF spectrum band module, a base station communications module, a network communications module, and a system communications management module, Input/Output (I/O) ports, I/O components, and power supply (not explicitly shown in FIG. 1). Each of these components may be in communication with each other, directly or indirectly, over one or more buses 140. In one implementation, the node 100 may be a UE or a base station that performs various functions described herein, for example, with reference to FIG. 1 through 13.

The transceiver 120 having a transmitter 122 (e.g., transmitting/transmission circuitry) and a receiver 124 (e.g., receiving/reception circuitry) may be configured to transmit and/or receive time and/or frequency resource partitioning information. In some implementations, the transceiver 120 may be configured to transmit in different types of subframes and slots including, but not limited to, usable, non-usable and flexibly usable subframes and slot formats. The transceiver 120 may be configured to receive data and control channels.

The node 100 may include a variety of computer-readable media. Computer-readable media can be any available media that can be accessed by the node 100 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable.

Computer storage media includes RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices.

Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 134 may include computer-storage media in the form of volatile and/or non-volatile memory. The memory 134 may be removable, non-removable, or a combination thereof. Exemplary memory includes solid-state memory, hard drives, optical-disc drives, and etc. As illustrated in FIG. 14, the memory 134 may store computer-readable, computer-executable instructions 132 (e.g., software codes) that are configured to, when executed, cause the processor 128 to perform various functions described herein, for example, with reference to FIG. 1 through 13. Alternatively, the instructions 132 may not be directly executable by the processor 128 but be configured to cause the node 100 (e.g., when compiled and executed) to perform various functions described herein.

The processor 128 (e.g., having processing circuitry) may include an intelligent hardware device, e.g., a Central Processing Unit (CPU), a microcontroller, an ASIC, and etc. The processor 128 may include memory. The processor 128 may process the data 130 and the instructions 132 received from the memory 134, and information through the transceiver 120, the base band communications module, and/or the network communications module. The processor 128 may also process information to be sent to the transceiver 120 for transmission through the antenna 136, to the network communications module for transmission to a core network.

One or more presentation components 138 presents data indications to a person or other device. Exemplary presentation components 138 include a display device, speaker, printing component, vibrating component, and etc.

It is noted that the RS ID mentioned above can be replaced by some other ID which can explicitly or implicitly indicates the gNB the new beam.

It is noted that all the designs/embodiment/implementations introduced within this disclosure are not limited to be applied for dealing with the problem mention within this disclosure. For example, them can be applied to solve any of problem existed in radio access network of cellular wireless communication system.

It is noted that all the number listed within the designs/embodiment/implementations introduced within this disclosure are just an example for illustration how the method is executed.

It is noted that the downlink RRC message mentioned in the present disclosure may be but not limited to be RRCReconfiguration, RRCResume, RRCReestablishment, RRCSetup or any other downlink unicast RRC message.

It is noted that “a specific configuration is per UE configured” or “a specific configuration is configured for a UE” mentioned in the present disclosure may represented as the specific configuration may be but not limited to be configured within a downlink RRC message.

It is noted that “a specific configuration is per cell group configured” or “a specific configuration is configured for a cell group” mentioned in the present disclosure may represented as the specific configuration may be but not limited to be configured within a CellGroupConfig, MAC-CellGroupConfig or PhysicalCellGroupConfig IE.

It is noted that “a specific configuration is per serving cell configured” or “a specific configuration is configured for a serving cell” mentioned in the present disclosure may represented as the specific configuration may be but not limited to be configured within a ServingCellConfigCommon, ServingCellConfig, PUSCH-ServingCellConfig or PDSCH-ServingCellConfig IE.

It is noted that “a specific configuration is per UL BWP or per BWP configured” or “a specific configuration is configured for a UL BWP or for a BWP” mentioned in the present disclosure may represented as the specific configuration may be but not limited to be configured within a BWP-Uplink, BWP-UplinkDedicated, BWP-UplinkCommon, PUSCH-ConfigCommon or PUSCH-Config IE.

It is noted that “a specific configuration is per DL BWP or per BWP configured” or “a specific configuration is configured for a DL BWP or for a BWP” mentioned in the present disclosure may represented as the specific configuration may be but not limited to be configured within a BWP-Downlink, BWP-DownlinkDedicated, BWP-DownlinkCommon, PDSCH-ConfigCommon or PDSCH-Config IE.

It is noted that the “transmitted” within all the implementations/embodiments introduced above can be defined as corresponding MAC CE/MAC PDU/layer 1 signaling/higher layer signaling, is started to be transmitted or completely transmitted or is already delivered to corresponding HARQ process/buffer for transmission. The “transmitted” within all the implementations/embodiments introduced above can also be defined as the HARQ_ACK feedback (response from gNB) of the MAC PDU carrying the MAC CE/MAC PDU/layer 1 signaling/higher layer signaling is received. The “transmitted” within all the implementations/embodiments introduced above can also be defined as corresponding MAC CE/MAC PDU is built. It is noted that the “HARQ_ACK feedback” can be implemented as a DCI format 0_0, 0_1 or some other format of DCI was received by the UE from the gNB on PDCCH. The received DCI contains a new data indicator (NDI) which is set to a specific value (e.g., set to 1) and the DCI also indicating a HARQ process ID which same as a HARQ process ID applied by/indicated to be used for the HARQ process of the MAC PDU (carrying the BFRQ MAC CE) transmission.

The PDCCH mention in the present disclosure is transmitted by the gNB to the UE. Or we can say the PDCCH is received by the UE from the gNB. The PDSCH mention in the present disclosure is transmitted by the gNB to the UE. Or we can say the PDSCH is received by the UE from the gNB. The PUSCH mention in the present disclosure is transmitted by the UE to the gNB. Or we can say the PUCCH is received by the gNB from the UE.

A PDSCH/PDSCH/PUSCH transmission may spanning multiple of symbols in time domain. A time duration of a PDSCH/PDSCH/PUSCH (transmission) implies a time interval starts from the beginning of the first symbol of the PDSCH/PDSCH/PUSCH (transmission) and end at the end of the last symbol of the PDSCH/PDSCH/PUSCH (transmission).

The term “A and/or B” within the present disclosure means “A”, “B” or “A and B”. The term “A and/or B and/or C” within the present disclosure means “A”, “B”, “C”, “A and B”, “A and C”, “B and C” or “A and B and C”.

The term “A/B” within the present disclosure means “A” or “B”.

The term “interrupt” within the present disclosure may have the same meaning as “stop”, “cancel” or “skip” in the present disclosure.

The term “instruct the PHY to generate acknowledgement” can have the same meaning as “instruct the PHY to perform HARQ-ACK feedback” in the present disclosure.

The term “acknowledgement” may have the same meaning as “HARQ-ACK” or “HARQ-ACK feedback” in the present disclosure.

It is noted that “the UE may not need to perform the corresponding HARQ feedback” in the present disclosure may equal to “the HARQ entity/HARQ process may not need to perform the corresponding HARQ feedback”

In the present disclosure, “by specific Physical layer signaling” may be but not limited to be: By a specific format of DCI; By a specific field of a DCI; By a specific field of a DCI, and the field is set to a specific value; or By a DCI with CRC bits scrambled with a specific RNTI.

From the above description, it is manifested that various techniques may be used for implementing the concepts described in the present application without departing from the scope of those concepts. Moreover, while the concepts have been described with specific reference to certain implementations, a person of ordinary skill in the art would recognize that changes may be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method of hybrid automatic repeat request (HARQ) process for multicast broadcast service (MBS), adapted to a user equipment (UE), wherein the method comprising:
receiving first downlink control information (DCI) on a first physical downlink control channel (PDCCH) scrambled by a first radio network temporary identifier (RNTI), wherein the first DCI comprises a first new data indicator (NDI) value and schedules a first downlink data reception on a first physical downlink shared channel (PDSCH) corresponding to a HARQ process;
receiving second DCI on a second PDCCH scrambled by a second RNTI, wherein the second DCI comprises a second NDI value and schedules a second downlink data reception on a second PDSCH corresponding to the HARQ process;
identifying a first type of the first RNTI and a second type of the second RNTI; and
determining, according to the first type and the second type, whether the first NDI value and the second NDI value are used for determining the second downlink data reception corresponds to an initial transmission or a retransmission of the first downlink data reception.

2. The method of claim 1, further comprising:
in response to the second type corresponding to a group RNTI and the first type corresponding to a UE specific RNTI, determining the second downlink data reception corresponds to the initial transmission or the retransmission without using the first NDI value and the second NDI value, wherein the group RNTI is configured by a gNB to associate with a first transmission type for a group of UE, and the UE specific RNTI is configured by the gNB to associate with a second transmission type for a single UE.

3. The method of claim 2, wherein the step of determining the second downlink data reception corresponds to the initial transmission or the retransmission without using the first NDI value and the second NDI value comprising:
in response to the second type being different from the first type, determining the second downlink data reception is the initial transmission.

4. The method of claim 1, further comprising:
receiving a radio resource control (RRC) message indicating a group RNTI associated with an MBS bearer.

5. The method of claim 1, further comprising:
in response to both of the first type and the second type corresponding to a group RNTI, determining the second downlink data reception corresponds to the initial transmission or the retransmission by using the first NDI value and the second NDI value.

6. The method of claim 5, wherein the step of determining the second downlink data reception corresponds to the initial transmission or the retransmission by using the first NDI value and the second NDI value comprising:
determining the second downlink data reception corresponds to the initial transmission in response to the second NDI value being different from the first NDI value; and
determining the second downlink data packet corresponds to the retransmission in response to the second NDI value being the same as the first NDI value.

7. The method of claim 1, further comprising:
in response to the second type corresponding to a UE specific RNTI, determining the second downlink data reception corresponds to the initial transmission or the retransmission by using the first NDI value and the second NDI value.

8. The method of claim 7, wherein the step of determining the second downlink data reception corresponds to the initial transmission or the retransmission by using the first NDI value and the second NDI value comprising:
determining the second downlink data reception corresponds to the initial transmission in response to the second NDI value being different from the first NDI value; and
determining the second downlink data reception corresponds to the retransmission in response to the second NDI value being the same as the first NDI value.

9. The method of claim 1, further comprising:
decoding data from the second downlink data reception in response to determining the second downlink data reception corresponds to the initial transmission; and
soft combining data received from the first downlink data reception and the second downlink data reception in response to determining the second downlink data reception corresponds to the retransmission.

10. A user equipment, comprising:
one or more non-transitory computer-readable media having computer-executable instructions embodied thereon; and
at least one processor coupled to the one or more non-transitory computer-readable media, and configured to execute the computer-executable instructions to:
receive first downlink control information (DCI) on a first physical downlink control channel (PDCCH) scrambled by a first radio network temporary identifier (RNTI), wherein the first DCI comprises a first new data indicator (NDI) value and schedules a first downlink data reception on a first physical downlink shared channel (PDSCH) corresponding to a HARQ process;
receive second DCI on a second PDCCH scrambled by a second RNTI value, wherein the second DCI comprises a second NDI value and schedules a second downlink data reception on a second PDSCH corresponding to the HARQ process;
identify a first type of the first RNTI and a second type of the second RNTI; and
determine, according to the first type and the second type, whether the first NDI value and the second NDI value are used for determining the second downlink data reception corresponds to an initial transmission or a retransmission of the first downlink data reception.
